(19) United States
(12) Patent Application Publication
(10) Pub. No.: US 2008/0156122 A1
(43) Pub. Date: Jul. 3, 2008

(54) Wafer inspection machine and method

(75) Inventors: Se Youl Oh, Gumi-si (KR); Hyeok Jin Koh, Gumi-si (KR)

Correspondence Address: GREER, BURNS & CRAIN, 300 S WACKER DR, 25TH FLOOR, CHICAGO, IL, 60606, US

(73) Assignee: SILTRON INC., Gumi-city (KR)

(21) Appl. No.: 12/004,082

(22) Filed: Dec. 19, 2007

(30) Foreign Application Priority Data
Dec. 29, 2006 (KR) 10-2006-0138733

(51) Int. Cl. G01M 19/00

(52) U.S. Cl. 73/865.8

(57) ABSTRACT

The present invention relates to wafer inspection machine and method. The wafer inspection machine comprises an inspection stage having a first area for unloading an inspected wafer and loading a new wafer to be inspected, and a second area for inspecting a wafer; a plurality of wafer mounting units installed on the inspection stage to face each other; a rotating plate on which a plurality of the wafer mounting units are installed, making a rotation such that each wafer mounting unit is located on the first and second areas in turn; a robot for unloading the inspected wafer from the wafer mounting unit located on the first area and loading a new wafer to be inspected in the wafer mounting unit located on the first area; and a wafer inverting means for inverting the wafer loaded in the wafer mounting unit located on the second area.

### BACKGROUND OF THE INVENTION

1. Field of the Invention

The present invention relates to wafer inspection machine and method, and in particular, to wafer inspection machine and method that integrate steps of a water inspection process to reduce loss time between the steps.

2. Description of the Related Art

Generally, a wafer is sliced from a single crystal ingot, and through a serial of processes including grinding, polishing and etching, the wafer is manufactured as a product with a predetermined level of flatness and mirror surfaces.

However, through the processes, surface defects caused by various factors or surface contamination caused by particles may occur to the wafers. The surface defects or contamination make it difficult to process the wafer into a semiconductor device. Thus, a wafer surface inspection process is required to remove a bad wafer having surface defects or contamination.

The wafer surface inspection process may use electronic equipments or laser beams, and inspection using laser beams may be replaced by or supplemented with an operator's visual observation.

The inspection using operator's visual observation is performed such that light of a lamp is illuminated on surfaces of a wafer and the operator observes the light reflected on the surfaces of the wafer with the naked eye.

In the case that a wafer has surface defects or contamination, distortion occurs to the reflected light, and thus the operator can determine if the wafer has surface defects or contamination.

Conventionally, a wafer surface inspection process is performed on the extracted samples, however, recently is performed on wafers in whole to meet the demands for minimization, large capacity and high quality.

Generally, such a complete wafer surface inspection process is performed in a clean room provided with clean air to prevent fabrication-completed wafers from being contaminated in an inspection process.

Hereinafter, a structure of a conventional wafer inspection machine is described with reference to FIG. 1, and a conventional wafer inspection method is described with reference to FIG. 2.

Referring to FIGS. 1 and 2, the wafer inspection machine 10 includes a wafer (W) to be inspected, a Front Opening Unified Pod cassette (hereinafter referred to as a ‘FOUP cassette’) 20 for storing the wafer (W) to be inspected in a stack, a storage cassette 50 for storing the inspected wafer in a stack, a movable robot 11 moving along a moving rail 12 for transferring the wafer (W) to be inspected and the inspected wafer, an inspection stage 30 for inspecting the wafer (W), and a wafer inverting unit 40 installed at a side of the inspection stage 30 for inverting the wafer (W).

With regard to operation of the above-mentioned wafer inspection machine 10, first, the movable robot 11 takes out the wafer (W) from the FOUP cassette 20 (S11). Next, the movable robot 11 moves along the moving rail 12 and transfers the wafer (W) to the inspection stage 30 (S12). An operator (not shown) inspects with the naked eye a surface, in particular, an upper surface of the wafer (W) placed on the inspection stage 30 (S13). At this time, light is illuminated on the surface of the wafer (W) using a light source such as a halogen lamp (now shown), and the operator checks the disperse of light with the naked eye. Subsequently, the movable robot 11 transfers the upper surface-inspected wafer (W) to the wafer inverting unit 40 (S14). The wafer inverting unit 40 inverts the wafer (W) upside down (S15). The movable robot 11 transfers the inverted wafer (W) to the inspection stage 30 again (S16). The inspection stage 30 inspects a lower surface of the wafer (W) (S17). Here, the lower surface of the wafer (W) is inspected in the same way as the upper surface of the wafer (W). The movable robot 11 transfers the both surfaces-inspected wafer (W) to an adjustment unit, i.e. the storage cassette 50 (S18). Finally, the wafer (W) is stored in the storage cassette 50 (S19).

As described above, the conventional wafer inspection process is performed on each a single wafer (W) through a total 9 steps. As a result, the conventional wafer inspection process requires much loss time between the steps to reduce efficiency of wafer inspection.

The present invention is designed to solve the problems, and therefore, it is an object of the present invention to provide a wafer inspection machine having an inspection stage with two areas, which allows simultaneous wafer inspection and new wafer loading/inspected wafer unloading to minimize loss time between steps, and a wafer inspection method.

It is another object of the present invention to provide a wafer inspection machine applicable to all automated equipments required for wafer handling, and a wafer inspection method.

### SUMMARY OF THE INVENTION

In order to achieve the above-mentioned objects, a wafer inspection machine comprises an inspection stage having a first area where an inspected wafer is unloaded and a new wafer to be inspected is loaded, and a second area where a wafer is inspected; a plurality of wafer mounting units installed on the inspection stage to face each other; a rotating plate on which a plurality of the wafer mounting units are installed, making a rotation such that each wafer mounting unit is located on the first and second areas in turn; a robot for unloading the inspected wafer from the wafer mounting unit located on the first area and loading a new wafer to be inspected in the wafer mounting unit located on the first area; and a wafer inverting means for inverting the wafer loaded in the wafer mounting unit located on the second area.

Preferably, after wafer inspection is completed on the second area, the rotating plate rotates to move the wafer mounting unit of the second area to the first area and the wafer mounting unit of the first area to the second area.

Preferably, the wafer inverting means has a support moving upwards to a predetermined height and downwards to an original position for inverting the wafer; and a guide bar installed at the top of the support for taking out the wafer from the wafer mounting unit located on the second area, inverting the wafer when the support is moved upwards to a predetermined height, and placing the wafer on the wafer mounting unit when the support is moved downwards to an original position.

According to another aspect of the present invention, a wafer inspection method uses a wafer inspection machine including an inspection stage having a first area where an inspected wafer is unloaded and a new wafer to be inspected is loaded and a second area where a wafer is inspected and a plurality of wafer mounting units installed on the inspection stage to face each other, and the method comprises (a) unloading an inspected wafer from the wafer mounting unit located on the first area and loading a new wafer to be inspected in the wafer mounting unit located on the first area; (b) moving the wafer mounting unit located on the first area to the second area by rotation; (c) inspecting a upper surface of the wafer loaded in the wafer mounting unit moved to the second area by rotation; (d) inverting the wafer using a wafer inverting means and inspecting a lower surface of the wafer; and (e) moving the wafer mounting unit located on the second area to the first area by rotation, wherein the step (a) is performed simultaneously with the steps (c) and (d).

Preferably, the step (d) for inverting the wafer includes taking out the wafer from the wafer mounting unit; moving the wafer upwards to a predetermined height; inverting the wafer by rotation; and placing the inverted wafer on the wafer mounting unit again.

Preferably, the inspected wafer unloading and new wafer loading completion time on the first area is prior or equal to the wafer inspection completion time on the second area.

### BRIEF DESCRIPTION OF THE DRAWINGS

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation.

FIG. 1 is a plan view illustrating a structure of a conventional wafer inspection machine.

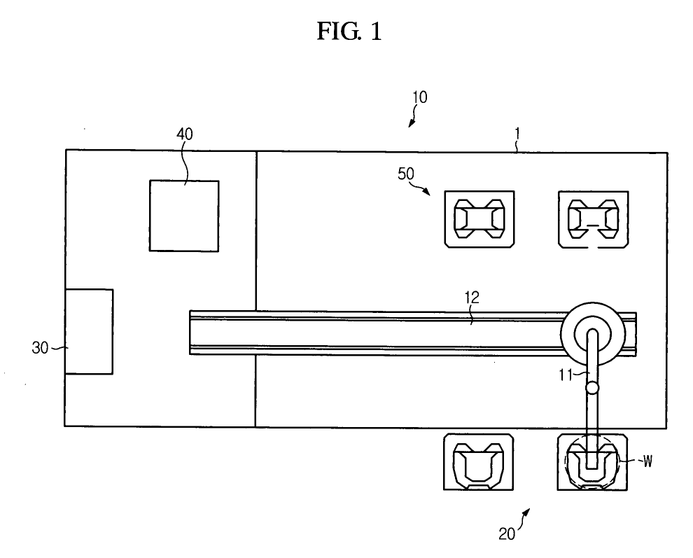

FIG. 2 is a flow chart illustrating a conventional wafer inspection method using the wafer inspection machine of FIG. 1.

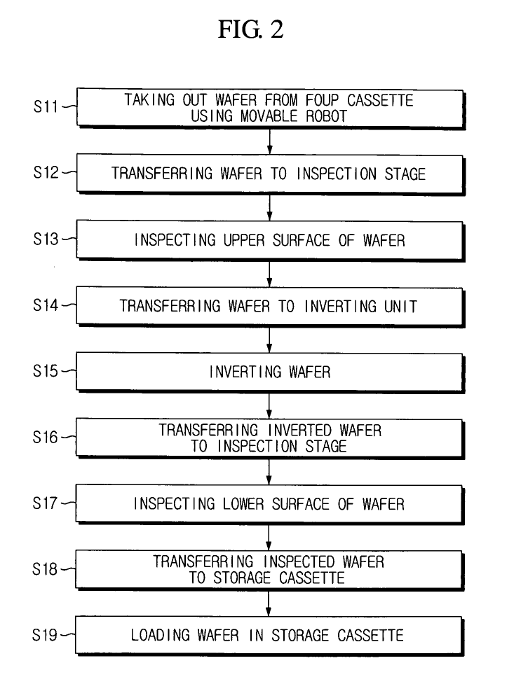

FIG. 3 is a schematic plan view illustrating a structure of a wafer inspection machine according to a preferred embodiment of the present invention.

FIG. 4 is a front cross-sectional view illustrating the wafer inspection machine according to a preferred embodiment of the present invention.

FIG. 5 is a plan view illustrating a wafer inverting means in FIG. 4.

FIG. 6 is a flow chart illustrating a wafer inspection method according to a preferred embodiment of the present invention.

FIG. 7 is a flow chart illustrating a step for unloading an inspected wafer and loading a new wafer to be inspected.

### DESCRIPTION OF THE PREFERRED EMBODIMENT

Hereinafter, preferred embodiments of the present invention will be described in detail with reference to the accompanying drawings.

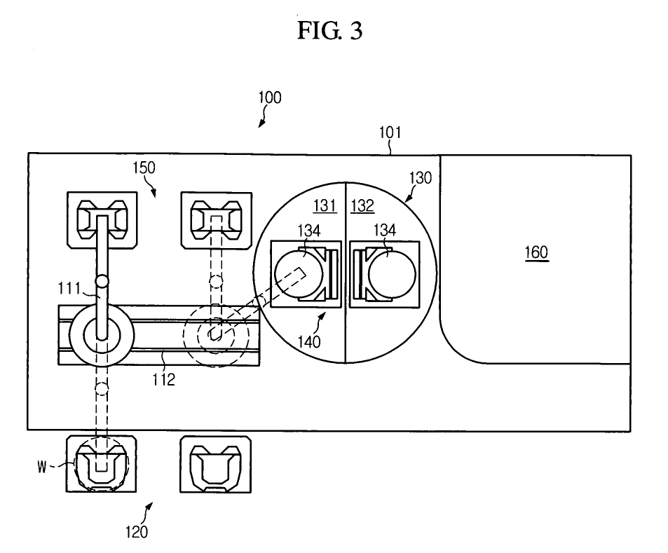

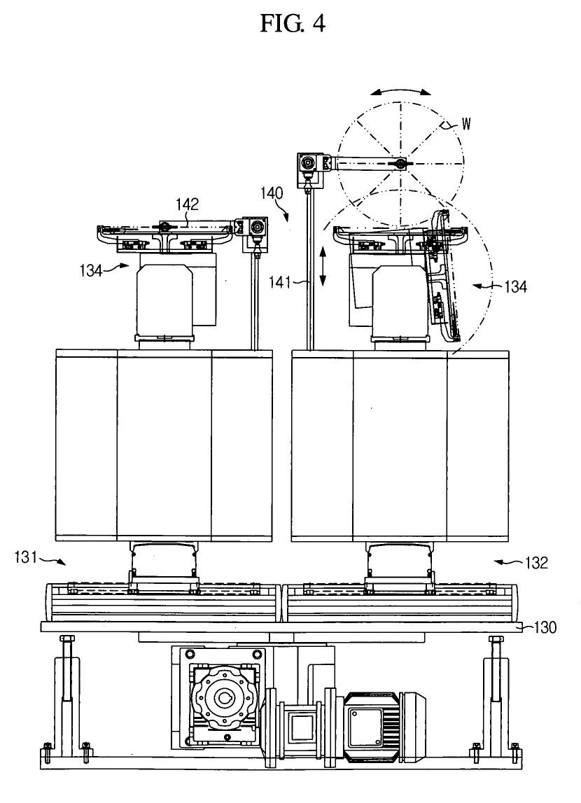

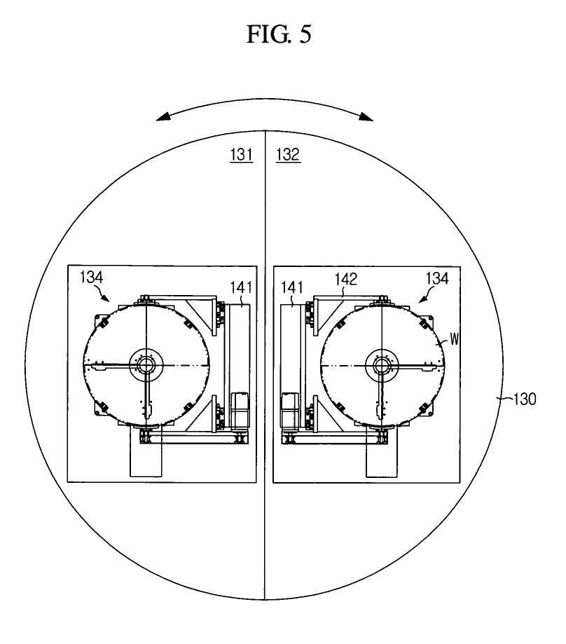

FIG. 3 is a schematic plan view illustrating a structure of a wafer inspection machine according to a preferred embodiment of the present invention. FIG. 4 is a front cross-sectional view illustrating the wafer inspection machine according to a preferred embodiment of the present invention. And, FIG. 5 is a plan view illustrating an inverting means in FIG. 4.

Referring to FIGS. 3 to 5, the wafer inspection machine 100 comprises a FOUP cassette 120 installed in a clean room 101 for storing a wafer (W) to be inspected, a storage cassette 150 for storing an inspected wafer, an inspection stage 130 having a plurality of wafer mounting units 134 for mounting the wafer (W) to be inspected during wafer inspection, a robot 111 for loading the wafer (W) to be inspected in the inspection stage 130, and for unloading the inspected wafer from the inspection stage 130 and loading the inspected wafer in the storage cassette 150, and a wafer inverting means 140 for inverting the wafer (W) loaded in the wafer mounting unit 134 of the inspection stage 130.

The robot 111 moves along a moving rail 112 installed in the clean room 101. And, the robot 111 transfers the wafer (W) to be inspected from the FOUP cassette 120 to the inspection stage 130 and the inspected wafer from the inspection stage 130 to the storage cassette 150. The robot 11 moving along the moving rail 112 is well known in the art and its description is omitted.

The inspection stage 130 includes a rotating plate 135 where a plurality of the wafer mounting units 134 are installed. The rotating plate 135 has a first area 131 for loading the wafer (W) and a second area 132 for inspecting the wafer (W). The rotating plate 135 switches the locations of the first area 131 and the second area 132 to each other. That is, the rotating plate 135 makes a rotation such that the location of the first area 131 is moved to the second area 132 and the location of the second area 132 is moved to the first area 131. For example, the rotating plate 135 rotates in a 180 degree arc, so that the locations of the first area 131 and the second area 132 are switched to each other.

A plurality of the wafer mounting units 134 is installed on the rotating plate 135. Preferably, two wafer mounting units 134 are each installed on the first area 131 and the second area 132. The two wafer mounting units 134 are arranged symmetrically to each other, and the locations of the wafer mounting units 134 are switched to each other by the rotating plate 135.

Although FIG. 3 shows two wafer mounting units 134 are each installed on the first area 131 and the second area 132, the present invention is not limited in this regard.

The robot 111 takes out a wafer (W) to be inspected from the FOUP cassette 120, moves to the inspection stage 130 along the moving rail 112, and loads the wafer (W) in the wafer mounting unit 134 located on the first area 131 of the inspection stage 130 that is located away from a wafer inspection area 160. Then, as the rotating plate 135 rotates in a 180 degree arc, the location of the wafer mounting unit 134 having the wafer (W) is moved to the second area 132 that is located adjacent to the wafer inspection area 160. Thus, an operator (not shown) can inspect the wafer (W).

Meanwhile, the wafer mounting unit 134 located on the first area 131 by rotation of the rotating plate 135 has no wafer (W) to be inspected or has the inspected wafer. When a new first wafer is inspected on the second area 132, any wafer (W) to be inspected is not loaded in the wafer mounting unit 134 of the first area 131. When a new second wafer and thereafter are inspected on the second area 132, the inspected wafer is loaded in the wafer mounting unit 134 of the first area 131. In due course, while wafer inspection is performed in the wafer mounting unit 134 of the second area 132, the robot 111 loads a new wafer (W) to be inspected in the wafer mounting unit 134 of the first area 131, or unloads the inspected wafer from the wafer mounting unit 134 of the first area 131. A step for loading/unloading a wafer will be described in detail.

During wafer inspection, the wafer mounting unit 134 may be rotated at a predetermined angle. Preferably, the wafer mounting unit 134 located on the second area 132 is rotated at a angle between 45 and 90 degrees. This allows the operator to easily observe the wafer (W) loaded in the wafer mounting unit 134 of the second area 132. At this time, although not shown, light is illuminated on the wafer (W) loaded in the wafer mounting unit 134 of the second area 132 using a halogen lamp, so that the operator can easily observe surface defects of contamination which may occur to the wafer (W).

The wafer inverting means 140 is each installed at a side of the wafer mounting unit 134 for inverting the wafer (W) loaded in the wafer mounting unit 134.

The wafer inverting means 140 includes a support 141 and a guide bar 142 installed at the top of the support 141.

The support 141 is located at the center of the rotating plate 135, preferably between the two wafer mounting units 134. The support 141 is operated to move vertically. The support 141 of the first area 131 is operated independently from the support 141 of the second area 132, and preferably only the support 141 of the second area 132 is operated to invert the wafer (W).

The guide bar 142 is each installed at the top of the support 141. The guide bar 142 grips edges of the wafer (W) for inverting the wafer (W) and is formed in the shape of a square bracket ‘[’ or ‘]’. The guide bar 142 may use any means for rotating the wafer (W) to invert the wafer (W). For example, a motor may be used to rotate only a portion of the guide bar 142 gripping the edges of the wafer (W).

Meanwhile, the wafer inverting means 140 may be rotated with the rotating plate 135. At this time, the locations of the wafer mounting units 134 installed on the rotating plate 135 and the location of the wafer inverting means 140 are fixed.

Each operation of the above-mentioned wafer inspection machine 100 may be controlled by the operator. In other words, in an emergency or in the operator's judgment, the entire operation of the wafer inspection machine 100 may be selectively controlled by the operator using a controller (not shown).

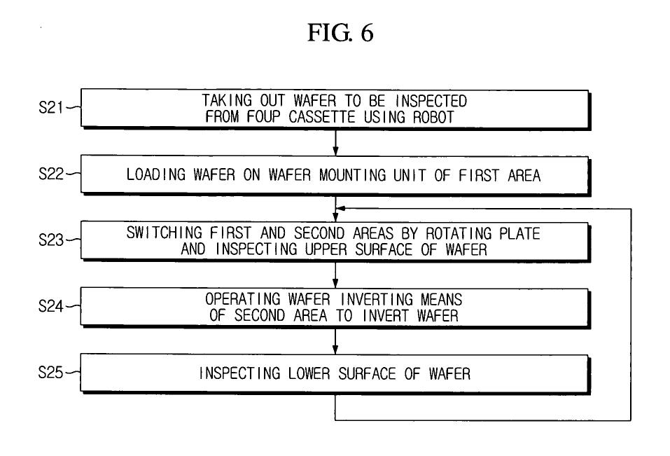

Hereinafter, a wafer inspection method using the wafer inspection machine is described with reference to FIG. 6.

First, the robot 111 takes out a wafer (W) to be inspected from the FOUP cassette 120 (S21).

Next, the robot 111 moves to the inspection stage 130 along the moving rail 112 and loads the wafer (W) in the wafer mounting unit 134 located on the first area 131 of the inspection stage 130 (S22).

Subsequently, as the rotating plate 135 rotates in a 180 degree arc, the location of the wafer mounting unit 134 located on the first area 131 is moved to the second area 132 (S23). Then, the location of the wafer (W) is moved adjacent to the wafer inspection area 160, and the operator inspects a surface, in particular an upper surface of the wafer (W) (S23). At this time, light is illuminated on the surface of the wafer (W) using a halogen lamp (not shown), which may lead to a convenient wafer inspection.

Subsequently, after one surface of the wafer (W) is inspected, the wafer inverting means 140 located on the second area is operated to invert the wafer (W) (S24). That is, while the edges of the wafer (W) are fixed to the guide bar 142 installed at the support 141 of the wafer inverting means 140 located on the second area 132, the support 141 is moved upwards. When the support 141 reaches a predetermined height, the guide bar 142 is rotated to invert the wafer (W). After the wafer (W) is inverted, the support 141 is moved downwards, so that the wafer (W) is placed on the wafer mounting unit 134.

After the wafer (W) is inverted by the wafer inverting means 140, a lower surface of the wafer (W) is inspected (S25). Here, the lower surface of the wafer (W) is inspected in the same way as the upper surface of the wafer (W).

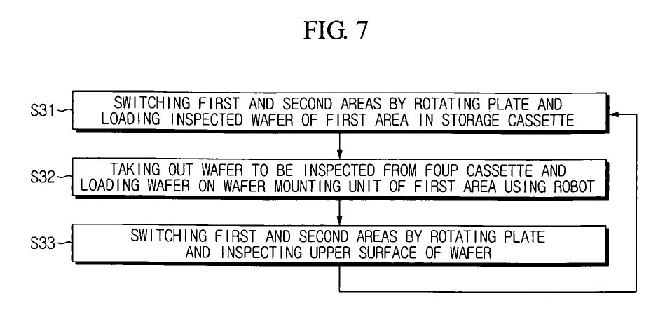

Meanwhile, the wafer inspection machine 100 includes two wafer mounting units 134, and thus is capable of inspecting the wafer (W) simultaneously with unloading the inspected wafer and loading a new wafer (W) to be inspected. A step for simultaneously inspecting and loading/unloading wafers is described with reference to FIG. 7.

First, when wafer inspection is completed on the second area 132, the rotating plate 135 is rotated in a 180 degree arc to change the location of the wafer mounting unit 134 having the inspected wafer to the first area 131. Then, the robot 111 unloads the inspected wafer from the wafer mounting unit 134 located on the first area 131 and loads the wafer in the storage cassette 150 (S31).

Next, the robot 111 takes out a new wafer (W) to be inspected from the FOUP cassette 120, moves to the inspection stage 130 and loads the wafer (W) in the wafer mounting unit 134 located on the first area 131 (S32).

After the wafer (W) to be inspected is loaded, the rotating plate 135 is rotated in a 180 degree arc to change the location of the wafer (W) located on the first area 131 to the second area 132, and the upper surface of the wafer (W) is inspected on the second area 132 (S33). Preferably, unloading of the inspected wafer and loading of a new wafer (W) to be inspected are performed during wafer inspection. At this time, preferably the new wafer loading completion time is prior to the wafer inspection completion time, and more preferably the new wafer loading completion time is prior to the wafer inspection completion time.

The present invention switches alternately the locations of the wafer mounting units 134 located on the first area 131 and the second area 132 to each other, so that the steps S23 to S25 and the steps S31 to S33 are performed at the same time, thereby inspecting the wafers without loss time between the steps.

Accordingly, the conventional wafer inspection machine performs a total 9 steps each a single wafer, whereas the wafer inspection machine 100 of the present invention initially performs a total 5 steps each a single wafer and thereafter performs a total 3 steps.

It should be understood that the detailed description and specific examples, while indicating preferred embodiments of the invention, are given by way of illustration only, since various changes and modifications within the spirit and scope of the invention will become apparent to those skilled in the art from this detailed description.

### APPLICABILITY TO THE INDUSTRY

The wafer inspection machine and method according to present invention have the following effects.

The present invention integrates steps of a wafer inspection process to inspect a wafer and load a new wafer to be inspected at the same time, thereby reducing loss time between the steps, i.e. tact time. Thus, the present invention increases the number of inspected wafers each unit time to improve the productivity of a wafer fabrication process. And, the present invention may be applicable to all automated equipments required for continuous wafer handling.

What is claimed is:

1. A wafer inspection machine, comprising:
an inspection stage having a first area for unloading an inspected wafer and loading a new wafer to be inspected, and a second area for inspecting a wafer;
a plurality of wafer mounting units installed on the inspection stage to face each other;
a rotating plate on which a plurality of the wafer mounting units are installed, the rotating plate making a rotation such that each wafer mounting unit is located on the first and second areas in turn;
a robot for unloading the inspected wafer from the wafer mounting unit located on the first area and loading a new wafer to be inspected in the wafer mounting unit located on the first area; and
a wafer inverting means for inverting the wafer loaded in the wafer mounting unit located on the second area.

2. The wafer inspection machine according to claim 1,
wherein, after wafer inspection is completed on the second area, the rotating plate rotates to move the wafer mounting unit located on the second area to the first area and the wafer mounting unit located on the first area to the second area.

3. The wafer inspection machine according to claim 1,
wherein the wafer inverting means includes:
a support moving upwards to a predetermined height and downwards to an original position for inverting the wafer; and
a guide bar installed at a top of the support for taking out the wafer from the wafer mounting unit located on the second area, for inverting the wafer when the support is moved upwards to a predetermined height, and for placing the wafer on the inverted wafer mounting unit when the support is moved downwards to an original position.

4. A wafer inspection method using a wafer inspection machine including an inspection stage having a first area for unloading an inspected wafer and loading a new wafer to be inspected and a second area for inspecting a wafer, and a plurality of wafer mounting units installed on the inspection stage to face each other, the method comprising:
(a) unloading an inspected wafer from the wafer mounting unit located on the first area and loading a new wafer to be inspected in the wafer mounting unit located on the first area;
(b) moving the wafer mounting unit located on the first area to the second area by rotation;
(c) inspecting an upper surface of the wafer loaded in the wafer mounting unit moved to the second area by rotation;
(d) inverting the wafer using a wafer inverting means and inspecting a lower surface of the wafer; and
(e) moving the wafer mounting unit located on the second area to the first area by rotation,
wherein the step (a) is performed simultaneously with the steps (c) and (d).

5. The wafer inspection method according to claim 4,
wherein the step (d) for inverting the wafer includes:
taking out the wafer from the wafer mounting unit;
moving the wafer upwards to a predetermined height;
inverting the wafer by rotation; and
placing the inverted wafer on the wafer mounting unit again.

6. The wafer inspection method according to claim 4,
wherein inspected wafer unloading and new wafer loading completion time on the first area is prior or equal to wafer inspection completion time on the second area.
